(19) United States
(12) Patent Application Publication
(10) Pub. No.: US 2007/0279246 A1
(43) Pub. Date: Dec. 6, 2007

(54) Remote control with easy to detect buttons

(76) Inventor: Mildred A. Hudspeth, Moreno Valley, CA (US)

Correspondence Address: SUNG I. OH, PROFESSIONAL LAW CORPORATION, 710 QUAIL VALLEY LANE, WEST COVINA, CA, 91791, US

(21) Appl. No.: 11/444,213

(22) Filed: May 30, 2006

(51) Int. Cl. H04N 5/44; G08C 19/00

(52) U.S. Cl. 340/825.69; 348/734

(57) ABSTRACT

A hand held remote control has buttons that light up and has magnifying elements to make indicia on the buttons more visible in low light situations. The buttons also contain braille for sight-impaired users.

### TECHNICAL FIELD OF THE INVENTION

The present invention relates to the general art of hand held remote controls, and to the particular field of remote controls used to control electronic devices, such as televisions, DVD players, and the like.

### BACKGROUND OF THE INVENTION

Remote controls have become increasingly popular in recent years for controlling the function of various electronic devices such as televisions, video cassette recorders and stereo equipment. These remote controls typically include a hand-held housing on which a key pad having a plurality of different buttons is mounted. The selective pressing of keys on the key pad results in a corresponding function being carried out in the electronic equipment with which the remote control communicates.

Such remote controls are commonly utilized with program listings and the like to which a user refers in order to determine which channel to view, listen to, or record. The entries of such program listings and the like are frequently printed in comparatively small type, making reading thereof difficult, particularly for the elderly and those with impaired eyesight.

As such, it would be beneficial to provide a means for enhancing a user's ability to read the printed matter of such program listings and the like so as to facilitate easier use thereof.

Additionally, it is a common practice for a user to watch television, use a VCR, and/or listen to a stereo in a situation wherein the lighting conditions are insufficient for comfortable reading of program listings and the like. For example, people frequently watch television while resting upon a bed with the lights turned low or off.

In such situations of inadequate lighting, it is also difficult to identify the individual controls of the remote control, thus making operation thereof difficult. For instance, when it is desired to change a television channel utilizing the remote control, one must frequently press several of the buttons of a remote control before the correct button is found. Pressing the wrong buttons occasionally has an undesirable effect such as increasing or decreasing the volume or even turning the controlled device off.

In such circumstances, it is generally undesirable to turn on the lights or otherwise increase illumination. It is often inconvenient to turn on the lights, particularly in those circumstances wherein it is necessary to leave the bed and walk across the room to a light switch. Furthermore, one may desire to maintain such a low level of lighting so as not to disturb another person who is resting or sleeping nearby.

As such, it is desirable to provide illumination means for a remote control wherein the illumination means allows the user to easily read printed matter such as program listings and also allows the user to readily identify the individual controls of the remote control.

The inventor is aware of self-contained illumination devices. The most typical device of this kind is the common flashlight, having a case, batteries, a lamp with reflector and an on-off switch. However, such a device cannot be used to solve the above identified problem because of a flashlight's bulk and inability to be attached to the remote control.

In the instance where the user is sight impaired, it would be desirable to provide a means for magnifying or enhancing a user's ability to read printed matter such as television listings, regardless of the level of illumination.

### SUMMARY OF THE INVENTION

The above-discussed disadvantages of the prior art are overcome by a hand held remote control which has buttons that light up and which has magnifying elements to make indicia on the buttons more visible in low light situations. The buttons also contain braille for the sight impaired.

Using the remote control embodying the present invention will permit a user with sight disabilities to use the control even in low light situations.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a remote control unit embodying the present invention.

FIG. 2 is a detail view of a control button on which braille indicia is located.

FIG. 3 is a perspective view of a remote control unit having a lighting unit thereon.

FIG. 4 is a perspective view of a remote control unit having a lighting unit therein.

FIG. 5 is a perspective view of a remote control unit embodying the present invention having a magnifying panel thereon.

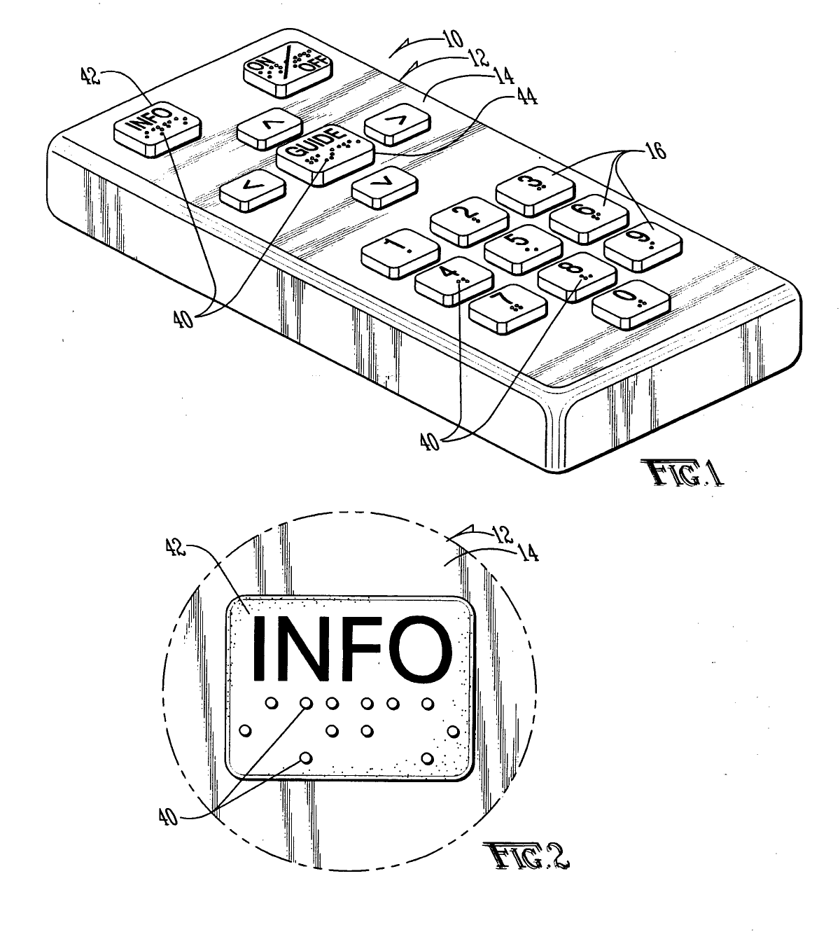

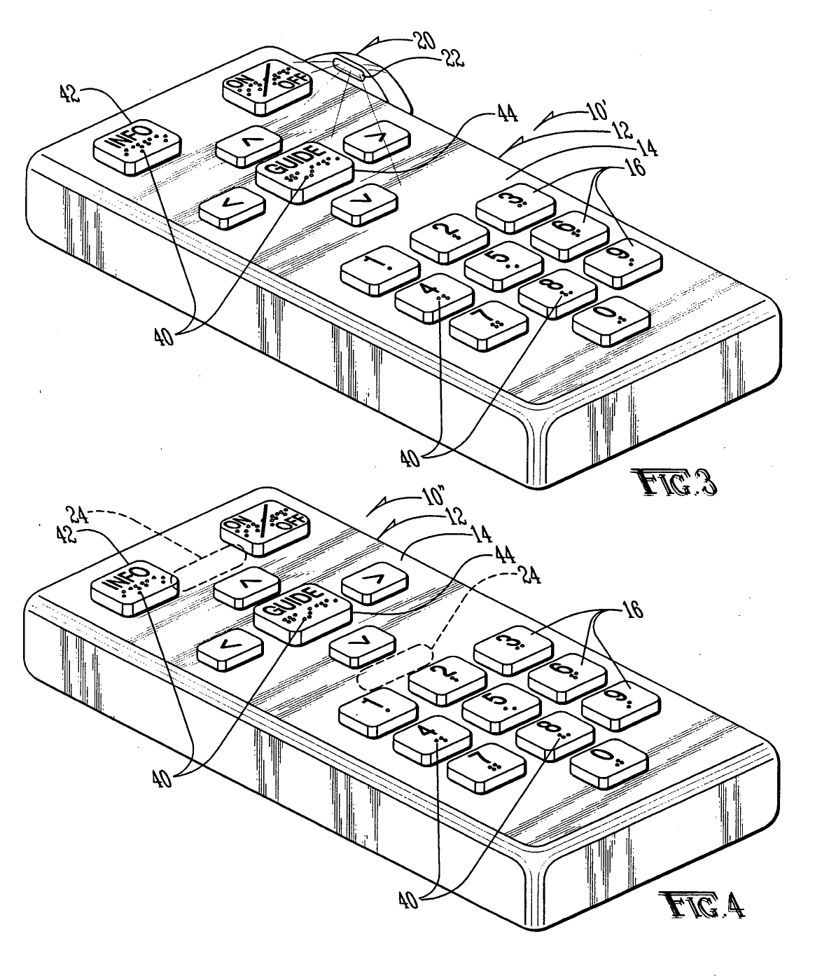

### DETAILED DESCRIPTION OF THE INVENTION

Referring to the figures, it can be understood that the present invention is embodied in a remote control 10 which comprises a housing 12 which has a surface 14 that is a top surface when the housing is in use. A plurality of control buttons, such as control buttons 16, are located on surface 14. The control buttons are part of a circuit that is contained in the housing for remotely controlling electronic equipment, such as televisions, DVD players, audio equipment, or the like. The circuit is well known and the details of the circuit are not important to the present invention. As such, the details of the circuit associated with the remote control will not be presented or claimed.

The control buttons can be oversized as compared to the control buttons used on prior art remote control units. Unit 10 further includes lighting means. One form of lighting means is indicated in FIG. 3 for unit 10′ as including an illuminator 20 disposed proximate to the housing and which is configured to cast light from a source 22 onto the control buttons to enhance viewing of the controls thereof. The illuminator may either be integrally formed with the housing or removably attachable thereto.

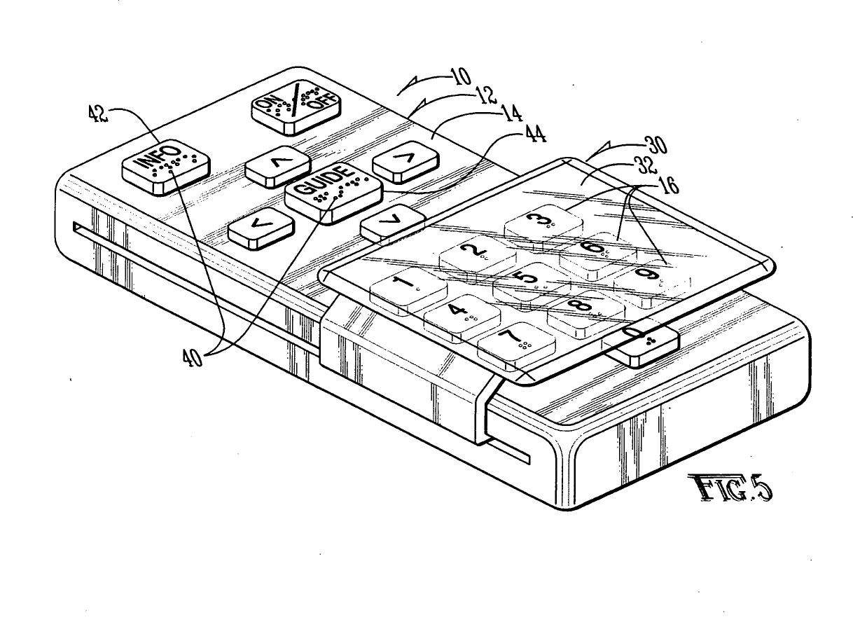

A second form of illuminator is indicated in FIG. 4 by reference numeral 24 in unit 10″ and is incorporated into the control buttons. The control buttons are fabricated from a translucent plastic material, and an illuminating means is located within the housing of the remote control device. The illuminating means casts light upward through the buttons.

As shown in FIG. 5, unit 10^{III} further comprises a magnifier unit 30 which enhances a user's ability to read printed matter on the control buttons. The magnifier may either be integrally formed with the housing as shown in FIG. 5 as magnifier sheet 32 or removably attachable thereto. A hook and loop fastening strap or the like may be used for facilitating removable attachment of the magnifier to the housing. Each control button includes braille indicia, such as braille indicia 40 on control buttons 42 and 44. The braille indicia is associated with the button and the operation associated with the button so a sight-impaired user will know what function he or she is selecting for each button.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A remote control unit comprising:
A) a housing having a first surface which is a top surface when the housing is in use;
B) a plurality of control buttons on the first surface;
C) a lighting unit in the housing and associated with each button to light up the button when the lighting unit is activated;
D) a magnifying unit on the housing, the magnifying unit being located proximate to the control buttons to magnify indicia on each control button of the plurality of control buttons; and
E) braille indicia on each control button.

2. The remote control unit defined in claim 1 wherein the control buttons are individually lighted.

3. The remote control unit defined in claim 1 wherein the magnifying unit is movably attached to the housing.
